(19) United States
(12) Patent Application Publication
(10) Pub. No.: US 2008/0050570 A1
(43) Pub. Date: Feb. 28, 2008

(54) Method for Treating a Super Capacity Electrode Film in Order to Create Porosity and Associated Machine

(75) Inventors: Helene Drevet, Quimper (FR); Isabelle Rey, Quimper (FR); Guy Le Gal, Quimper (FR); Michel Peillet, Ergue Gaberic (FR)

Correspondence Address: BLAKELY SOKOLOFF TAYLOR & ZAFMAN, 1279 OAKMEAD PARKWAY, SUNNYVALE, CA, 94085-4040, US

(73) Assignee: BATSCAP, Ergue Gaberic (FR)

(21) Appl. No.: 11/596,102

(22) PCT Filed: May 13, 2005
(86) PCT No.: PCT/FR05/01208

§ 371 Date: Nov. 9, 2006

(30) Foreign Application Priority Data
May 13, 2004 (FR) 0405181

(51) Int. Cl. B32B 27/00; B08B 3/08; H01B 1/20

(52) U.S. Cl. 428/219; 134/105; 134/15; 252/500; 428/220

(57) ABSTRACT

The invention relates to a method for treating a super capacitor electrode film (12) obtained by extruding a mixture of polymers and active charges without a solvent, said mixture comprising at least one soluble polymer. The method comprises a step in which an extractable part of the soluble polymer(s) is eliminated by immersing the film in an aqueous or organic solvent of said polymers. The invention is characterized in that the stage in which the polymer(s) is/are eliminated comprises sub-steps consisting in continuously placing the film (12) in a washing container (101) containing the solvent, wherein the solvent is kept at a controlled temperature; in rinsing the film, drying the film in a continuous manner and winding the film.

The invention concerns the area of the treatment of polymer films intended for the formation of electrodes. These electrodes are used in devices for the storage of electrical energy such as capacitors, supercapacitors and generators or batteries.

Films that are intended for the formation of electrodes of devices for the storage of energy based on liquid electrolyte (including solvent and salts) must have a high specific area and a good accessibility of the electrolyte to the active charges contained in the electrode. In fact, the quality of impregnation of the electrode by the electrolyte determines the performance of the resulting energy storage device (in particular its resistance and its capacity).

The electrode films can be created by the extrusion of a mixture of polymers and carbonated active charges. The mixture contains insoluble polymers and one or more soluble or calcinable polymers. In the “no solvent” extrusion techniques, the mixture is subjected to a plastification method, and the active charges are coated by the polymers. To this end, the mixture is extruded, and then the soluble or calcinable polymer or polymers are eliminated so as to form pores. This type of technique is described in document FR 2 759 087-A (published on 7 Aug. 1998), for example.

The problem set by the techniques of extrusion without solvent is that the proportion of active charges contained in the mixture is necessarily limited. In fact, the rate of incorporation of active charges in a plastified polymer is limited by the specific area of the active charges. The higher the rate of active charges contained in the mixture, the more the mechanical properties of the film obtained have tendency to decrease.

This is why the proportion of polymer forming the electrodes is relatively high in general, leading to the achievement of electrodes that have a high resistance and a reduced capacity.

One objective of the invention is to propose an automated method for the treatment of film used to create electrode films that have an improved storage capacity per unit volume and improved conductivity.

To this end, the invention proposes a method for the processing of a supercapacitor electrode film, created by the extrusion of a mixture of polymers and active charges without solvent, the mixture including at least one polymer that is soluble in an aqueous or organic solvent, said method including a step of eliminating of an extractable part of the soluble polymer or polymers by immersion of the film in the aqueous or organic solvent of the said polymer, characterised in that the step of eliminating of the soluble polymer or polymers includes the following sub-steps:

continuously running the film through at least one wash tank containing the solvent, with the solvent being held at a controlled temperature,
rinsing the film,
drying the film continuously, and
rolling the film.

The method of the invention to achieve maximum elimination of the soluble polymer or polymers while continuously running the film in the washing tank.

The washing sub-step never succeeds in eliminating the entirety of the polymers contained in the initial mixture. Only a part, called the “extractable part”, of the soluble polymer or polymers present in the initial mixture is eliminated. The other part remains associated with the active charges contained in the mixture.

The washing sub-step leads an increase in the porosity of the film and of the proportion of active charges that it contains.

Apart from this, the continuous drying method avoids giving rise to sudden dimensional variations of the film due to the thermal shrinkage generated by the heating and a change of phase of the mixture constituting the film (the mixture passes from a partially dissolved swollen state to a solid state).

The invention also concerns a machine for the methoding of a supercapacitor electrode film, which is created by the extrusion of a mixture of polymers and active charges without solvent, where the mixture includes at least one polymer that is soluble in an aqueous or organic solvent, where the said machine includes means eliminating an extractable part of the soluble polymer or polymers by immersion of the film in the aqueous or organic solvent of the said polymer, characterised in that the means for eliminating the soluble polymer or polymers include means for continuously pulling the film through a washing tank containing the aqueous or organic solvent, means for controlling and maintaining the temperature of the solvent, means for rinsing the film, means for drying the film continuously, and means for rolling the film.

Other characteristics and advantages will emerge from the following description, which is purely illustrative and not limiting in any way, and should be read with reference to the appended figures, in which:

FIG. 1 schematically represents a machine for the methoding of an electrode film according to a first method of implementation of the invention,

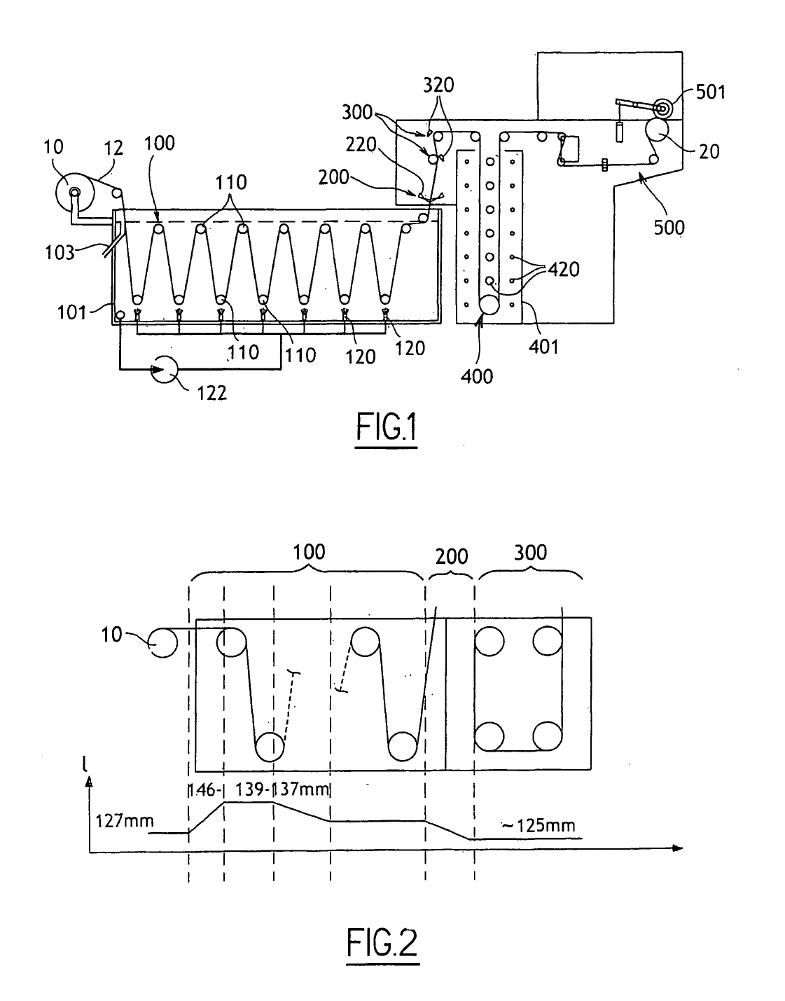

FIG. 2 schematically illustrates the width variations of a strip of film during the steps for washing and drying the film,

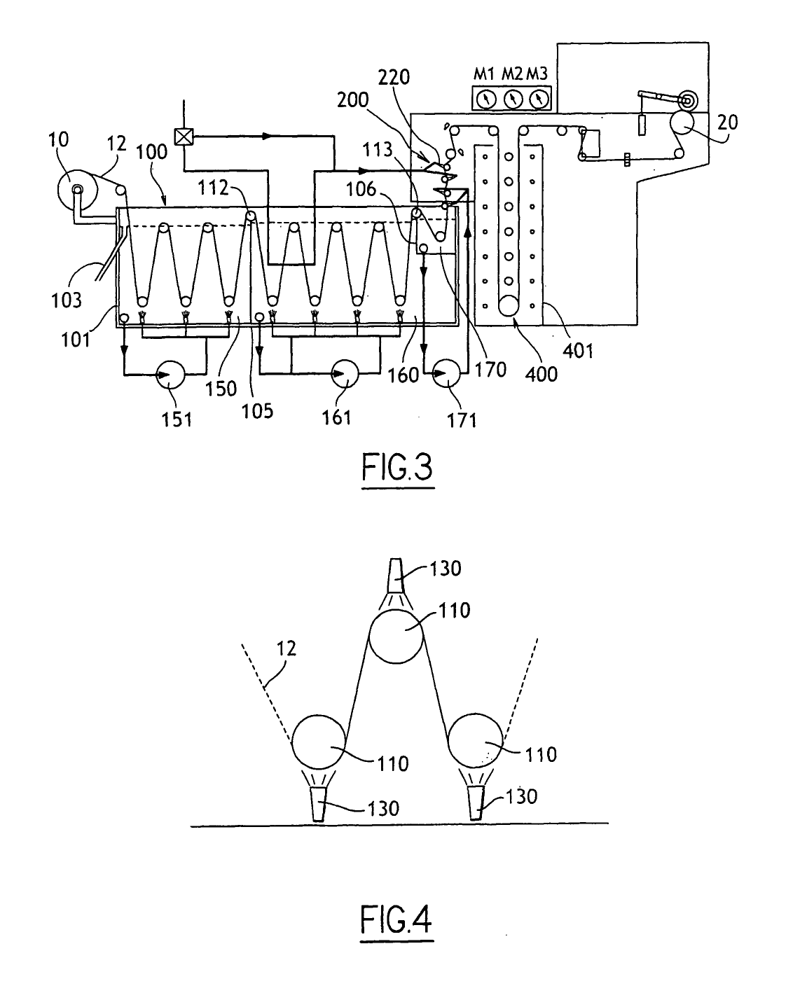

FIG. 3 schematically represents a machine for the methoding of an electrode film according to a second method of implementation of the invention,

FIG. 4 schematically illustrates a variant of the washing means that can be implemented,

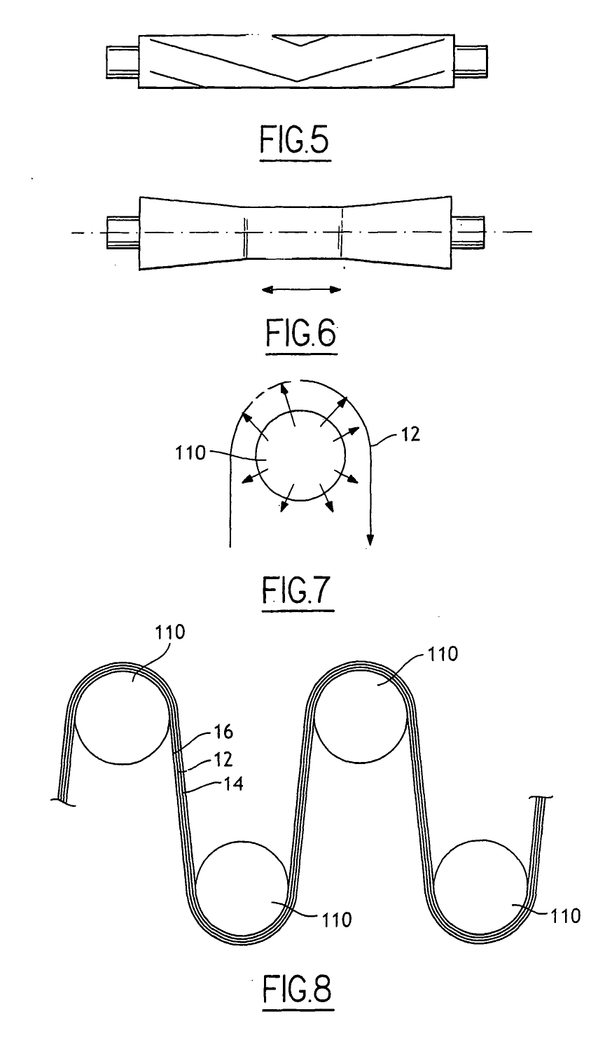

FIGS. 5 and 6 schematically illustrate methods for the implementation of rollers on the strip of film to be treated travels,

FIG. 7 schematically illustrates in cross section a roller used to improve the travel of the film strip,

FIG. 8 schematically represents a fragile electrode film sandwiched between two support layers during its treatment.

In FIG. 1, the illustrated methoding machine in general includes a washing station 100, a rinsing station 200, a pre-drying station 300, a drying station 400 and a rolling station 500.

An electrode film 12 with a thickness of between 80 and 200 μm is unrolled from a feed spool 10 and pulled along and guided by rollers through the various treatment stations.

The film 12 first passes through the washing station 100. The washing step is used to eliminate the soluble polymer or polymers which constitute the film. The washing station 100 includes a washing tank 101 filled with solvent. The level of the solvent is held constant in the tank 101 by means of an overflow system 103. The electrode film 12 is pulled and guided through the tank 101 by a series of rollers 110 positioned parallel to each other across the direction of travel of the film. The rollers 110 are of the smooth type, semi-driven by belts. As can be seen in FIG. 1, the rollers 110 are positioned alternately close to the bottom of the tank 101 and close to the surface of the solvent. The electrode film 12 is located alternately below the rollers located close to the bottom of the tank and above the rollers located close to the surface of the solvent, so that the film follows a zigzag trajectory in the tank. This characteristic is used to obtain a trajectory of maximum length for the film for a given tank volume, and as a consequence a maximum washing time. In fact the aim in this washing step is to favour as much as possible the dissolution of the soluble polymers.

The rollers 110 are designed to generate a minimum of tension in the film 12. To this end, the rollers include, for example, idling rollers on axles that are driven in rotation.

The solvent contained in the washing tank 101 is composed of water supplied by the mains water system or of demineralised water (obtained after methoding of the water from the mains supply system or of waste water in a closed loop). It has been seen that the presence of ionic and mineral compounds in the water from the mains water system can give rise, when these compounds exist in the electrode film after washing, to later oxidation/reduction (redox) reactions in the supercapacitance. This is why it is preferred to use demineralised water, which results in a reduction in these redox reactions and, as a consequence, prevents premature ageing of the electrode created, when it is used in a supercapacitor. The demineralised water can be obtained through treatment of the waste water in a closed loops for example. It has a conductivity of less than 10 μS/cm (microsiemens per centimetre).

The water in the washing tank 101 is held at a constant controlled temperature of between 20° and 90° Celsius, and preferably between 45° and 50° Celsius. For practical reasons, the temperature can be fixed at 47° Celsius for example, this which prevents the operators who have to manipulate the film manually from burning themselves when they have to plunge their hands into the tank 101. The water contained in the tank is heated and held at its temperature by convection heating means such as heating plates.

The water contained in the tank 101 is renewed continuously so that the concentration of dissolved polymers in the tank 101 is between 0 and 100 g/l (grams per litre). To this end, the tank 101 is supplied continuously with clean water while the surplus water is removed via the overflow 103.

The dimensions of the tank 101 as well as the positioning of the guide rollers 110 are determined so that the total immersion time of the film in the washing tank is more than 3 minutes, and preferably between about 3 and 10 minutes. Typically, if the film moves at a speed of about 2.5 m/min (metres per minute) and is located in the tank for a journey time of 8.5 m, this gives an immersion time of 3.4 minutes.

Nozzles 120 arranged in the bottom of the tank close to the rollers 110 spray the film with jets of water, and perform mixing of the water around the film by mechanical stirring. The water jets are fed by a pump 122 which draws in the water from the bottom of the tank 101 and re-injects it via the nozzles 120. This system of mixing by pumping and spraying onto the film is used to homogenise the temperature of the water in the washing tank and to favour the dissolution of the soluble polymers by the creation of a turbulent flow at the surface of the film.

The film 12 then travels through the rinsing station 200. The rinsing step is intended to eliminate the residues drawn by the film on its surface as it leaves the washing tank. The rinsing station 200 includes nozzles 220 which spray a rinsing solvent onto each face of the film.

It can be seen in FIG. 1 that the sprayed solvent flows along the film into the washing tank 101, and this keeps the latter supplied with solvent. In this configuration, the solvent used for rinsing is therefore the same as the solvent contained in the washing tank, that is the water supplied by the mains water system or demineralised water obtained from system for the recycling of waste water.

The rinsing solvent sprayed onto the film at rinsing position 200 is held at a temperature of between 10° and 90° Celsius.

The rinsing solvent is refreshed at a rate of between 1 and 5 litres per minute. The flow of the rinsing solvent is about 2 l/min (litres per minute) for example.

The film then travels through the pre-drying 300 and drying 400 stations. The objective of the pre-drying and drying steps is to remove enough of the water contained in the film so that the latter can be spooled at the end of the method without sticking of the turns on the spool. A concern during the pre-drying and drying steps is to organise a progressive evaporation of the water in order to avoid damaging the film.

The pre-drying station 200 includes two nozzles 320 arranged on either side of the film, and oriented across the direction of travel of the film. The nozzles 320 project a sheet of compressed air onto each of the faces of the film. The projected air is cold and dry.

The drying station 400 includes an enclosure 401 through which the film travels. The enclosure 401 includes a set of nozzles 420 blowing hot air at a temperature of between 50 and 120 degrees Celsius, and preferably 100 degrees Celsius. The film travels in the enclosure 401 for about one minute.

The station 500 for rolling up the film thus dried includes a film spool 20 that is driven in rotation, and onto which the methoded film is wound. The spool is formed by rolling the film on a mandrel. The rolling station 500 can include a pressure roller 501 which rotates on the surface of the spool 20 and presses the film onto the latter. This pressure roller 501 is intended to prevent any formation of folds in the spool.

FIG. 2 schematically shows the width variations of a strip of film against the various steps of treatment to which the film is subjected at the washing 100, pre-drying 200 and drying 300 stations. As can-be seen, the strip has an initial width of about 127 mm, during its passage through the washing station 100. The strip is initially subjected to swelling as the soluble polymer or polymers dissolve in the solvent. The strip thus passes from a width of 127 mm to a width of 142 mm. This width reduces during washing, to reach 139 mm and then 137 mm. The width of the strip then remains more-or-less constant during the remainder of the washing method.

During the passage of the film through the pre-drying station 200, the film is subjected to shrinking, which causes it to pass from a width of 137 mm to one of about 125 mm. This shrinking is due simultaneously to a phenomenon of thermal shrinkage of the film and to a change of phase of the polymers of which it is made. The polymers pass from a partially dissolved phase to a solid phase. The pre-drying step is used to eliminate most of the water contained in the film.

As can be seen in FIG. 2, the final drying step in the drying station 300 causes practically no change in the width of the strip. This step is intended to remove the remainder of water contained in the film.

It has been seen that the increase in the proportion of carbonated charges contained in the film, which arises from the elimination of soluble polymers, occurs mostly in the first third of the journey of the film in the washing tank 101. In fact, it is estimated that the elimination of about 90% by weight of the extractable part of the soluble polymer or polymers contained in the film occurs during the first 90 seconds of washing.

As a consequence, one solution in order to optimise the washing step consists of passing the film progressively through several washing tanks, where these washing tanks have a concentration of dissolved polymers which reduces with the distance covered by the film.

FIG. 3 illustrates a second embodiment of the processing machine, in which the washing tank 101 has been separated into three compartments 150, 160, and 170 by means of partitions 105 and 106 arranged across the tank 101. Rollers 112 and 113 have been raised so as raise the film 12 above the partitions 105 and 106 in order to pass it from one compartment to the other. The film thus begins by travelling through the first washing compartment 150, and then through the second washing compartment 160 and finally through the third compartment 170 which constitutes a pre-rinsing tank.

As can be seen in FIG. 3, the level of solvent in each of the compartments 150, 160 and 170 is adjusted respectively by the level of the overflow 103, the height of partition 105 and the height of partition 106. These levels are determined so that the solvent spills in a cascade from the pre-rinsing tank 170 to the second washing tank 160 over partition 1.05, and then to the first washing tank 150 over partition 106. In other words, the compartments 150, 160 of the washing tank 101 are fed in solvent by overflowing of the solvent contained respectively in the adjacent compartments 160, 170 in the direction opposite to that of the film 12. Thus, the concentration of dissolved polymers in the solvent reduces from one compartment to the next in the direction of travel of the film 12. The first washing compartment 150 is the compartment in which the concentration of polymers is highest. The pre-rinsing tank 170 is the compartment in which the concentration of dissolves polymers is the least high. In the second washing compartment 160, the concentration is intermediate. In each compartment 150, 160, 170 the concentration of dissolved polymers in the solvent that it contains is constant.

The compartment 150 through which the film first travels is dimensioned so that the extraction of at least 90% by weight of the soluble polymer or polymers takes place in the said compartment 150.

In a manner similar to the embodiment of FIG. 1, the pre-rinsing tank 170 is fed by the solvent sprayed from the rinsing nozzles 220 of the rinsing station 200. The solvent flows along the film and into the rinsing tank 170. The rinsing solvent sprayed from the rinsing nozzles is water supplied by the mains water system or demineralised water obtained from a system for the recycling of waste water. The water circuit feeding the nozzles 220 passes through the second washing tank 160 so as to heat the water that it conducts by thermal exchange with the washing tank. Thus, the water sprayed by the nozzles 220 is heated water.

The water contained in the pre-rinsing tank 170 is mixed by a pump system 171 which draws the water from the bottom of the compartment and re-injects it at the rinsing nozzles of the rinsing station 200.

Likewise, the water contained in the washing compartments 150 and 160 is mixed by independent pump systems 151 and 161 similar to the system 122 of FIG. 1. The solvent drawn in from each compartment 150, 160, 170 flows in independent mixing circuits, which means that the compartments are kept at different concentrations. In this method of implementation, the mixing rates of each of the systems 151, 161 and 171 can be adapted independently of each other.

Other implementations of the invention can be envisaged of course.

In particular, for the extraction of the soluble polymers, it is possible to use organic solvents, of the alcohol family (ethanols, methanols, etc.) for example, or aqueous solvents such as water containing salts (such as Na2SO4), or the water containing tensioactive products contributing to wettability of the soluble polymers.

Concerning the mixing techniques employed, the pumping and spraying systems can be replaced by mechanical stirrers positioned at the bottom the washing or rinsing tank or tanks.

Concerning the washing step, the extraction of the soluble polymers can be effected not by immersion of the film in a solvent but by the spraying of solvent onto the film, as illustrated in FIG. 4. In this figure, while the film travels on rollers 110, nozzles 130, positioned close to the rollers, spray a solvent onto both faces of the film under pressure. With such a washing technique, the journey times are approximately equivalent to that required for washing by immersion. The number of spray nozzles and the solvent pressure can be adapted (for example, the flow from each nozzle can be of the order of 2 l/min).

In addition, in the methods of implementation shown in FIGS. 1 and 3, the guide rollers 110 are smooth, semi-driven cylindrical rollers. In the case of washing by the spraying of solvent onto the film, this type of guidance can turn out to be unsuitable. These rollers do not allow the water to be removed in a convenient manner, since the latter is trapped between the rollers and the film. Apart from this, these rollers cannot be used to control the path of the film satisfactorily. In particular, the width of the film can vary because of lateral shifts to which the film is subjected in relation to the mean vertical plane of its path in the heating position 400, since these shifts increase the risk of film breakage.

In order to remedy this problem, rollers are used that have longitudinal grooves for the removal of solvent as shown in FIG. 5. On the roller shown in FIG. 5, grooves of a generally V shape lie in a generally longitudinal direction along the roller guide the solvent to the ends of the latter.

In addition, it is possible to use rollers formed from a concave or convex part. In particular, the rollers of the concave type have a concave shape which continuously forces the film into a given plane of travel, as illustrated in FIG. 6.

It can be seen that the water-removal grooves of FIG. 5 can be used on rollers of the concave type, like that shown in FIG. 6.

It is also possible to make use of the nature of the roller covering material. By alternating guide rollers with a metallic finish (steel for example) with one finished in an elastomer material (rubber for example), it is possible to control the extent of the transverse and longitudinal shrinkage of the film.

It is also possible to make use of the texture of the roller finish, using a spiked texture to favour removal of the water, for example.

It is also possible to use rollers that idle, that is to say rollers that rotate freely around their axles, and which present practically no mechanical resistance, or rollers with independent motor drive in order to adapt the traction exerted on the film according to the deformation to which it is subjected due to the dissolution method.

The film can also travel over a course of fixed cylindrical rollers, where these rollers have perforations through which a liquid, such as a solvent, is injected. As illustrated in FIG. 6, water is injected along the arrows. This injection creates a cushion of water between the roller and the film. This guidance technique of the “aquaplaning” type facilitates the motion of the film and avoids the generation of excessive stresses in the film. In addition, the fact of injecting water onto the film favours the dissolution of the soluble polymers by mechanical surface action.

Concerning the rinsing step, this can be effected not by spraying of solvent on the film as illustrates in FIG. 1, but by pulling the film through a rinsing tank containing a rinsing solvent proper, meaning one that has a concentration of dissolved polymers close to zero. In these conditions, the washing tank 101 is then fed with solvent by overflow of the solvent contained in the rinsing tank into the washing tank 101.

Concerning the drying stage, this can be effected by convection, using hot air (as illustrate in FIG. 1). In a variant, this drying step can be located in an enclosure under vacuum, through which the film travels 12. In another variant, the drying step can be effected by conduction, by pulling the film 12 over heated rollers or indeed by radiation.

The method that has just been described is suitable not only for the treatment of self-supporting electrode films, but also for the treatment of more fragile electrode films.

The expression “self-supporting” means a film whose composition is such that it possesses in itself a sufficient cohesion and mechanical strength in elongation so that it preserves its integrity during the treatment without being supported.

On the contrary, certain more fragile electrode films do not have sufficient cohesion and mechanical strength in elongation to cope with traction without damage. In this case, the treated film can be held during its travel and the various washing, rinsing and drying steps, by at least one support layer.

In the case where the film is methoded in treatment machines such that those shown in FIGS. 1 and 2, the film will preferably be sandwiched between two support layers 14 and 16 as illustrated in FIG. 8. Since the film 12 covers a zigzag trajectory in the washing tank, it will therefore be in contact with the rollers 110 alternately on each of its faces. Thus, each of the support layers 14 and 16 protects one of the surfaces of the film 12 in contact with the rollers 110.

The support layers 14 and 16 are composed of a perforated material that allows the film 12 to be in contact with the solvent during the washing and rinsing and drying steps. The support layers 14 and 16 can be formed, for example, from a non-woven material in hydrolysed polyester that have a surface density of 45 g/m2 (supplied by the THARREAU INDUSTRIES company under the reference AQUADIM 45 G NL).

Characteristics of the Films Treated

We will look at three self-supporting supercapacitor electrode films A, B and C formed by the extrusion of a mixture of polymers and of active charges.

Film A has a thickness e of 130 μm, and is formed from a mixture that includes a mechanical reinforcing polymer (fluoropolymer), water-soluble polymer (polyethers) and 34% by weight of active charcoal that has a measured surface BET of 990 m2/g.

Film B has a thickness e of 130 μm, and is formed from a mixture that includes a mechanical reinforcing polymer (fluoropolymer), a water-soluble polymer (polyethers), active charcoal and an conducting additive (carbon black).

Film C has a thickness e of 130 μm, and is formed from a mixture that includes a mechanical reinforcing polymer (fluoropolymer), a water-soluble polymer (polyethers), and 33.7% by weight of active charcoal with a measured specific area BET of 1035 m2/g.

The films A, B and C are methoded using the treatment method described previously.

The conductivity A of the film is measured in the direction of the film thickness, and the permeability of the film and the specific area BET of the film are measured in the direction perpendicular to the thickness of the film, meaning in a direction parallel to the surface of the film.

The measurement of conductivity in the direction of the thickness of the film A is effected using the following steps. A punch is used to cut from the film a sample in the form of a disk with a diameter D of 18 mm. Each of the faces of the sample is metallised by means of a suspension of silver. Then a copper wire is fixed onto each metallised face in order to connect the sample to a measuring instrument. The measuring instrument driven a current I between the two metallised faces, and measures the resulting voltage U. The conductivity ρ in the direction of the thickness of the film is determined as follows:

$$ρ = R \times \frac{S}{e}$$

where R is the resistance of the sample in the direction of the thickness of the film, S is the area of the sample perpendicular to the thickness of the film and e is the thickness of the film.
We then get

$$R = \frac{U}{I} and S = π \times \frac{{D}^{2}}{4} .$$

The measurement of conductivity in the direction perpendicular to the thickness of the film A (that is in a direction parallel to the surface of the film) is effected in accordance with the following steps. A sample is cut from the film in the form of a strip with dimensions w=1 cm×L=10 cm (width and length respectively). A four-terminal measuring instrument drives a current I between the two ends of the strip, and measures the resulting voltage U. To this end, two terminals are connected to either end of the strip, in order to drive the current, and two other terminals are connected to either end of the strip to measure the voltage. The conductivity ρ in the direction perpendicular to the thickness of the film is determined as follows:

$$ρ = R \times \frac{S}{L}$$

where R is the resistance of the sample in the direction perpendicular to the thickness of the film, S is the area of the sample in the direction of the thickness of the film, and L is the distance between the two points (more or less equal to the length of the strip).
We then get:

$$R = \frac{U}{I} and S = e \times w .$$

Measurement of the permeability of the film A is effected by the Darcy method, that is by the injection of a fluid (gas or solvent) into the porous film. The permeability to the gas is measured by means of refrigerated liquid nitrogen (diazote) and the permeability to solvent is measured by means of acetonitrile. The intrinsic permeability K is determined as follows:
k=K×η
where k is a constant that depends on the fluid used and on the material constituting the film, and η is the viscosity of the fluid.

We therefore get: V̅=k·Δ P̅

Where V̅ is the speed of the fluid in the sample and Δ P̅ is the pressure gradient in the sample.

The specific area BET of the films B and C is also measured.

The measurement of specific area BET (measured by the Brunauer, Emmett and Teller method) on samples of films B and C is achieved by means of a porosity meter as supplied, for example, by the Coulter company and references SA 3100.

The results of these measurements are grouped together in the following tables:

Film A

| | Before treatment | After treatment |
|---|---|---|
| Conductivity in the | 3.01 | 27.86 |
| direction of the | | |
| thickness | | |
| (mS/cm) | | |
| Conductivity in the | 0.063 | 0.131 |
| direction | | |
| perpendicular to the | | |
| thickness of the film | | |
| (S/cm) | | |
| Permeability to gas | 0 | 0.172 |
| (Darcy method) | | |
| Permeability to the | 0 | 0.00138 |
| solvent | | |
| (Darcy method) | | |

| Films B and C | |
|---|---|
| Before treatment | After treatment |

Film

| | B | C | B | C |
|---|---|---|---|---|
| Specific area | 0.29 | 3.47 | 37.09 | 40.74 |
| BET (m2/g) | | | | |

It can be seen that the treatment method enables us to create a film with a conductivity in the direction of the thickness of the film of between 20 and 30 mS/cm (milliSiemens per centimetre), a conductivity in a direction perpendicular to the thickness of the film of between 0.1 and 2 S/cm (Siemens per centimetre) and a specific area (BET) of between 30 and 45 m2/g.

1. A method for the processing of a supercapacitor electrode film (12), which is created by the extrusion of a mixture of polymers and of active charges without solvent, where the mixture includes at least one polymer that is soluble in an aqueous or organic solvent, said method including a step of eliminating an extractable part of the soluble polymer or polymers by immersion of the film (12) in the aqueous or organic solvent of the said polymer, wherein the step of eliminating the soluble polymer or polymers includes sub-steps consisting of:
continuously running the film (12) through at least one washing tank (101) containing the solvent, with the solvent being held at a controlled temperature,
rinsing the film,
drying the film continuously, and
rolling up the film.

2. A method according to claim 1, wherein the washing solvent is chosen from among the following compounds: water, organic solvents such as the alcohols, and mixtures of water+salts or water+tensioactive substances.

3. A method according to claim 2, wherein the washing solvent is alcohol, in particular ethanol or methanol.

4. A method according to claim 2, wherein the washing solvent is water.

5. A method according to claim 4, wherein the solvent is demineralised water.

6. A method according to claim 4, wherein the water has a conductivity of less than 10 μS/cm (microsiemens per centimetre).

7. A method according to claim 1, wherein the washing tank (101) is separated into several compartments (150, 160, 170) in which the film (12) travels successively.

8. A method according to claim 7, wherein one compartment (150, 160) of the washing tank (101) is fed with solvent by overflowing of the solvent contained in an adjacent compartment (160, 170) in the opposite direction to that of the film (12).

9. A method according to one of claims 7 or wherein in each compartment (150, 160, 170) the concentration of dissolved polymers in the solvent that it contains is constant.

10. A method according to claim 7, wherein the concentration of dissolved polymers in the solvent reduces from one compartment (150, 160, 170) to the next in the direction of travel of the film (12).

11. A method according to one of claims 6 or 7, wherein during the sub-step of eliminating the soluble polymer or polymers, the elimination of at least some 90 % by weight of the extractable part of the soluble polymer or polymers is effected in the compartment (150) in which the film (12) travels first.

12. A method according to claim 1, wherein the sub-step of the eliminating the extractable part of the soluble polymer or polymers leads to the extraction of at least some 90% by weight of the soluble polymer or polymers during the first 90 seconds of film travel in the washing tank (101).

13. A method according to claim 1, wherein the temperature of the solvent contained in the washing tank (101) is between 10 and 90 degrees Celsius, and preferably between 45 and 50 degrees Celsius.

14. A method according to claim 1, wherein the solvent contained in the washing tank (101) is heated by convection resources.

15. A method according claim 1, wherein the concentration of dissolved polymers in the washing tank (101) is of the order of 10 to 100 g/l.

16. A method according to claim 1, wherein journey time of the film (12) in the washing tank (101) is of the order of 3 to 10 minutes.

17. A method according to claim 1, wherein the washing tank (101) is separated into several compartments (150, 160, 170) each equipped with an independent mixing circuit (151, 161, 171).

18. A method according to claim 17, wherein the solvent contained in at least one of the compartments (150, 160, 170) of the washing tank is mixed by pumping resources and by spraying of the solvent onto the film (12).

19. A method according to claim 17, wherein the solvent contained in at least one of the compartments (150, 160, 170) of the washing tank (101) is mixed by mechanical stirring resources.

20. A method according to claim 1, wherein the film (12) pulled along in the washing tank (101) on rollers, with these rollers being designed to generate a minimum of tension in the film (12).

21. A method according to claim 20, wherein the rollers include idling rollers on axles that are driven in rotation.

22. A method according to claim 1, wherein during the rinsing sub-step, the film (12) is rinsed by a rinsing solvent, with the rinsing solvent being heated.

23. A method according to claim 1, wherein during the rinsing sub-step, the film (12) is rinsed by a rinsing solvent whose temperature is between 10 and 90° Celsius.

24. A method according to claim 1, wherein during the rinsing sub-step, the film (12) is pulled along in a rinsing tank containing a rinsing solvent with a concentration of dissolved polymer approaching zero.

25. A method according to claim 1, wherein the washing tank (101) is fed with solvent by overflowing of the solvent contained in a rinsing tank in which the film is rinsed into the washing tank (101).

26. A method according to one claim 1, wherein during the rinsing sub-step, the film (12) is subjected to spraying of rinsing solvent, with the said solvent flowing into the washing tank (101).

27. A method according to claim 1, wherein during the rinsing sub-step, the film (12) is rinsed by a rinsing solvent, where the rinsing solvent is water.

28. A method according to claim 27, wherein the rinsing solvent is demineralised water.

29. A method according to claim 1, wherein during the rinsing sub-step, the film (12) is rinsed by a rinsing solvent, with the rinsing solvent being refreshed at a rate of between 1 and 5 litres per minute.

30. A method according to claim 1, wherein the film (12) is pulled along on rollers of the smooth type, semi-driven by belts (110).

31. A method according to claim 1, wherein the film (12) is pulled along on a roller that has longitudinal grooves for the removal of the solvent to the ends of the roller.

32. A method according to claim 1, wherein the film (12) is pulled along on a roller formed from a concave or convex part.

33. A method according to claim 1, wherein the film (12) is pulled along on a roller whose surface is spiked.

34. A method according to claim 1, wherein the film (12) is pulled along alternately on rollers that have a metallic finish, like steel for example, and rollers that are covered in an elastomer material such as rubber.

35. A method according to claim 1, wherein the film is pulled along on rollers equipped with independent motor drives.

36. A method according to claim 1, wherein the film (12) is pulled along on a roller with perforations through which a liquid such as solvent is injected, where this injection creates a cushion between the roller and the film.

37. A method according to claim 1, wherein the drying sub-step is effected by convection, by causing the film (12) to run in an enclosure (401) in hot air at a temperature between 50 and 120 degrees Celsius, and preferably 100 degrees Celsius.

38. A method according to claim 1, wherein the drying sub-step is effected in an enclosure under vacuum in which the film travels (12).

39. A method according to claim 1, wherein the drying sub-step is effected by conduction, by causing the film (12) to run on heating rollers.

40. A method according to claim 1, wherein the drying sub-step is effected by radiation.

41. A method according to claim 1, wherein it includes a sub-step of drying the film, effected by the spraying of cold and dry compressed air.

42. A method according to claim 1, wherein the film (12) is held during its travels by at least one support layer (14, 16).

43. A method according to claim 42, wherein the film (12) is sandwiched between two support layers (14, 16).

44. A supercapacitor electrode film (12), formed by the extrusion of a mixture of polymers and active charges, wherein the film is processed by the method according to claim 1.

45. A film according to claim 44, wherein it has a thickness of between 80 and 200 μm.

46. A film according either of claims 44 or 45, wherein the film has a conductivity in the direction of the thickness of the film of between 20 and 30 mS/cm (milliSiemens per centimetre).

47. A film according to claim 44, wherein the film has a conductivity in a direction perpendicular to the thickness of the film of between 0.1 and 2 S/cm (Siemens per centimetre).

48. A film according claim 44, wherein the film has a specific area (BET) of between 30 and 45 m2/g.

49. A machine for processing a supercapacitance electrode film (12), which is created by the extrusion of a mixture of polymers and active charges without solvent, the mixture including at least one polymer that is soluble in an aqueous or organic solvent, the said machine including means (100) for eliminating an extractable part of the soluble polymer or polymers by immersion of the film (12) in the aqueous or organic solvent of the said polymer,
wherein the means (100) for eliminating the soluble polymer or polymers include means for continuously running the film (12) through at least one washing tank (101) containing the solvent, means for controlling and maintaining the temperature of the solvent, means (200) for rinsing the film, means (300, 400) for drying the film continuously, and means (500) for rolling up the film.

50. A machine according to claim 49, wherein the washing tank (101) is separated into several compartments (150, 160, 170) in which the film (12) travels successively.

51. A machine according to claim 50, wherein the compartment (150) in which the film (12) travels first is dimensioned so that the elimination of at least 90% by weight of the extractable part of the soluble polymer or polymers is effected in the said compartment (150).
